(19) United States
(12) Patent Application Publication
(10) Pub. No.: US 2024/0025121 A1
(43) Pub. Date: Jan. 25, 2024

(54) METHOD FOR PREVENTING DEPOSITS ON A NOZZLE PLATE

(71) Applicant: Ivoclar Vivadent AG, Schaan (LI)

(72) Inventors: Jonas Reinhardt, Igis (CH); Nicola Bitar, Montlingen (CH)

(21) Appl. No.: 18/355,864

(22) Filed: Jul. 20, 2023

(30) Foreign Application Priority Data
Jul. 21, 2022 (EP) 22186211.3
Jul. 12, 2023 (EP) 23184986.0

(51) Int. Cl. B29C 64/35; B29C 64/209; B33Y 40/00; B33Y 30/00

(52) U.S. Cl. CPC B29C 64/35; B29C 64/209; B33Y 40/00; B33Y 30/00; B29C 64/112

(57) ABSTRACT

A method for preventing deposits of a printing liquid at a nozzle plate (101) of a print head within a 3D printer (100), including the step of increasing a saturation level of a carrier liquid (103) of the printing liquid in the air in front of the nozzle plate (101).

### CROSS-REFERENCE TO RELATED APPLICATIONS

This application claims priority to European Application No. 22186211.3 filed on Jul. 21, 2022 and to European Application No. 23184986.0 filed on Jul. 12, 2023, the disclosures of which are incorporated herein by reference in their entirety.

### TECHNICAL FIELD

The present invention relates to methods for preventing deposits of a printing liquid at a nozzle plate of a print head within a 3D printer, and to a 3D printer having a print head comprising a nozzle plate.

### BACKGROUND

When printing aqueous slurries that include water and ceramic particles, the water evaporates at the nozzles, causing the solid to clog the nozzles. To prevent clogging of the nozzles, cleaning can be done in an ultrasonic bath or manually. Current printers include a cleaning device that can be started with the print head. The print head is normally moved into this via a damp cloth. However, cleaning can be achieved by various methods.

When jetting aqueous ceramic slurries or other water-based or hydrophilic materials using inkjet print heads, drying out of the slurry occurs on the bottom side of a nozzle plate. This leads to clogging of the nozzles when the humidity level of the surrounding atmosphere is lower than 90%. Although the slurry develops at the upper side of the nozzle plate, this is usually not sufficient to convert the dried particles in the nozzles back into a flowable slurry and to make the nozzles passable again.

US 2022048292, 2017106595, and 2015298394 are directed to 3-D printing systems and are hereby incorporated by reference.

### SUMMARY

It is the technical task of the present invention to prevent the formation of deposits on the bottom side of the nozzle plate of the print head and the drying out of print material in the nozzles of the nozzle plate.

This technical task is solved by the subject matters according to the independent claims. Technically advantageous embodiments are the subject matter of the dependent claims, the description and the drawings.

According to a first aspect, the technical task is solved by a method for preventing deposits of a printing liquid at a nozzle plate of a print head within a 3D printer, comprising the step of increasing a saturation level of a carrier liquid of the printing liquid in the air humidity in front of the nozzle plate. The carrier liquid may be water or any other suitable solvent known to one having ordinary skill in the art including, but not limited to, alcohols and glycols. In the case of water, the saturation level is the relative air humidity. The relative air humidity gives an immediate indication of the degree to which the air is saturated with water vapor. When increasing the saturation level of the carrier liquid in the air in front of the nozzle plate, the carrier liquid can precipitate at the nozzle plate. Conversely, a carrier liquid on the nozzle plate also increases the saturation level of the carrier liquid in the air in front of the nozzle plate. A film of the carrier liquid on the nozzle plate additionally reduces deposits. The method does not require a separate cleaning station to be started. In addition, the carrier liquid can be applied to the nozzle plate without contact, i.e., without a direct mechanical contact with another device, such as a sponge. During the method, for example, water-based slurry does not dry out on the bottom side of the nozzle plate or in the nozzles, so that nozzles cannot become clogged by dried slurry.

In a technically advantageous embodiment of the method, the nozzle plate is wetted with the carrier liquid. This achieves, for example, the technical advantage that a liquid film additionally prevents the formation of deposits at the nozzle plate.

In a further technically advantageous embodiment of the method, the carrier liquid is vapor-deposited onto the nozzle plate. This achieves, for example, the technical advantage that the carrier liquid can be applied evenly to the nozzle plate and a liquid film additionally prevents deposits.

In a further technically advantageous embodiment of the method, the carrier liquid is sprayed onto the nozzle plate. This achieves, for example, the technical advantage that the carrier liquid can be applied to the nozzle plate with little effort.

In a further technically advantageous embodiment of the method, the carrier liquid is nebulized in front of the nozzle plate. This has the technical advantage, for example, that the saturation level of the carrier liquid in front of the nozzle plate can be efficiently increased.

In a further technically advantageous embodiment of the method, an atmosphere with a high saturation level is generated locally in front of the bottom side of the nozzle plate. The saturation level is, for example, more than 50%, preferably more than 90%, highly preferably more than 95% and most preferably more than 99%. The local generation of the saturation level is achieved, for example, by a targeted air flow along the nozzle plate. This achieves the technical advantage of keeping the atmosphere moist directly in front of the bottom side of the nozzle plate. In this case, a water-based slurry cannot release water into the environment, so it does not dry out and remains flowable in the nozzles. The procedure can be carried out during the process (“on the fly”). The print head then does not need to be moved to a separate cleaning station.

In a further technically advantageous embodiment of the method, the carrier liquid is atomized by means of ultrasound. The atomization produces small droplets of the carrier liquid. This achieves, for example, the technical advantage that a mist of the carrier liquid can be generated with little effort.

In a further technically advantageous embodiment of the method, the carrier liquid on the nozzle plate is sucked in through the nozzles. This achieves, for example, the technical advantage that the nozzles of the nozzle plate remain functional, i.e. is passable.

In a further technically advantageous embodiment of the process, the carrier liquid is applied to the nozzle plate before, during or after a printing operation. This achieves, for example, the technical advantage that the nozzle plate is ready for operation at all times.

In a further technically advantageous embodiment of the method, the carrier liquid or air enriched with carrier liquid is discharged via an outlet nozzle or the carrier liquid is applied to the nozzle plate by means of a cloth or a sponge. The cloth or sponge may be lightly compressed in this process. The sponge or cloth can be attached to the side of the nozzle plate. In this case, they move together with the nozzle plate. This has the technical advantage, for example, that the saturation level can be increased directly in front of the nozzle plate.

In a further technically advantageous embodiment of the process, the carrier liquid or air enriched with carrier liquid is sucked off via a suction nozzle at the nozzle plate. This has the technical advantage, for example, that consumed carrier liquid or air with a reduced degree of saturation can be removed from the nozzle plate.

In a further technically advantageous embodiment of the process the carrier liquid for increasing the saturation level has a temperature above 50° C. This has the technical advantage, for example, that deposits on the nozzle plate can be removed efficiently.

In a further technically advantageous embodiment of the process the carrier liquid deposited on the nozzle plate is sucked by the nozzles. This has the technical advantage, for example, that the nozzle plate is cleaned automatically.

According to a second aspect, the technical task is achieved by a 3D printer with a nozzle plate, comprising a system for increasing a saturation level of a carrier liquid of the printing liquid in the air in front of the nozzle plate. The 3D printer achieves the same technical advantages as the method according to the first aspect.

In a technically advantageous embodiment of the 3D printer, the 3D printer comprises an evaporation device for generating vapor of the carrier liquid in front of the nozzle plate, an ultrasonic nebulizer for generating nebulized carrier liquid in front of the nozzle plate, and/or a sprayer for spraying the carrier liquid onto the nozzle plate. This achieves, for example, the technical advantage that the saturation level in front of the nozzle plate can be efficiently increased.

In a further technically advantageous embodiment of the 3D printer, an outlet nozzle for increasing the saturation level is arranged at the nozzle plate. This achieves, for example, the technical advantage that the air humidity can be increased directly in front of the nozzle plate.

In a further technically advantageous embodiment of the 3D printer, a suction nozzle for sucking off carrier liquid or air enriched with carrier liquid is arranged at the nozzle plate. This achieves, for example, the technical advantage that consumed carrier liquid or air with a reduced degree of saturation can be removed from the nozzle plate.

In a further technically advantageous embodiment of the 3D printer, the outlet nozzle is arranged on one side of the nozzle plate and the suction nozzle is arranged on the other side of the nozzle plate. This achieves the technical advantage, for example, that a high saturation level can be maintained by an air flow in front of the nozzle plate.

In a further technically advantageous embodiment of the 3D printer the 3D printer has a heater for heating the carrier liquid that is used for increasing the saturation level. This has the technical advantage, for example, that deposits on the nozzle plate can be removed efficiently.

In a further technically advantageous embodiment, by applying a vacuum in the liquid system of the printer to the nozzles, the re-dissolved solid is sucked in again from the bottom side of the nozzle plate via the nozzles. This achieves, for example, the technical advantage of making the nozzles functional again, i.e., passable.

### BRIEF DESCRIPTION OF THE DRAWINGS

Exemplary embodiments of the invention are illustrated in the drawings and are described in more detail below, in which:

FIG. 1 shows a schematic view of a 3D printer;

FIG. 2A shows a schematic view of a nozzle plate without deposits;

FIG. 2B shows a schematic view of a nozzle plate with deposits;

FIG. 3A shows a schematic view of a nozzle plate with a water film;

FIG. 3B shows a schematic view of a nozzle plate with a dissolved deposit;

FIG. 4 shows a schematic view of a humidification system for the print head;

FIG. 5 shows a further schematic view of a humidification system for the print head;

FIG. 6 shows a schematic view of a receptacle for a print head; and

FIG. 7 shows a schematic view of a print head and a water vapor generator.

### DETAILED DESCRIPTION

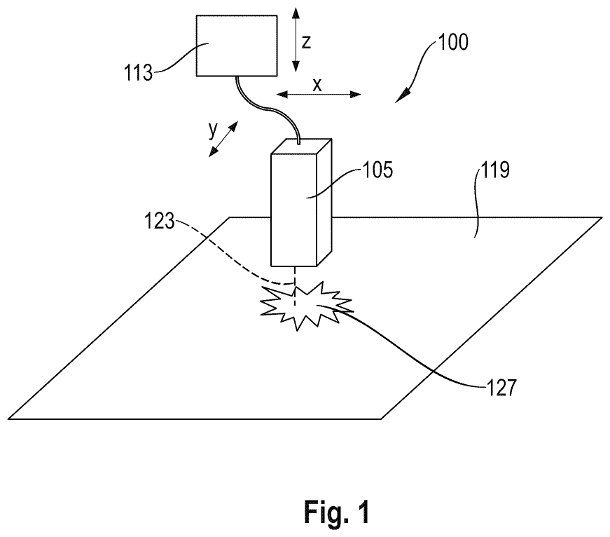

FIG. 1 shows a schematic view of a 3D printer 100. The 3D printer 100 performs a free-flow material application in an additive manufacturing process. In this process, raw material is selectively deposited in the form of small droplets of a printing liquid. In poly-jet or multi-jet modeling, a model is manufactured by a print head 105 with multiple linearly arranged nozzles.

The 3D printer 100, for example, uses the printing liquid in order to build up a dental restoration 127 layer by layer on an assembly platform 119. The printing liquid, for example, includes solid particles and a carrier liquid for the solid particles.

For printing, the material is spot-applied from the printing liquid by means of a print jet 123 from a plurality of nozzles. The print head 105 can be moved in the X-direction, Y-direction and Z-direction so that the print jet 123 can reach any position of the assembly platform 119. The printing liquid is fed to the print head 105 by means of a feeding device 113.

However, the problem arises here that deposits in the form of ink residues, foreign substances or sediments can form in the print head 105. These adhere to the inner surfaces of the liquid system inside the print head 105 and to the outside of the nozzle plate 101, so that over time they cause blockages and impair the function of the nozzles 107 (printing nozzle) and the print head 105.

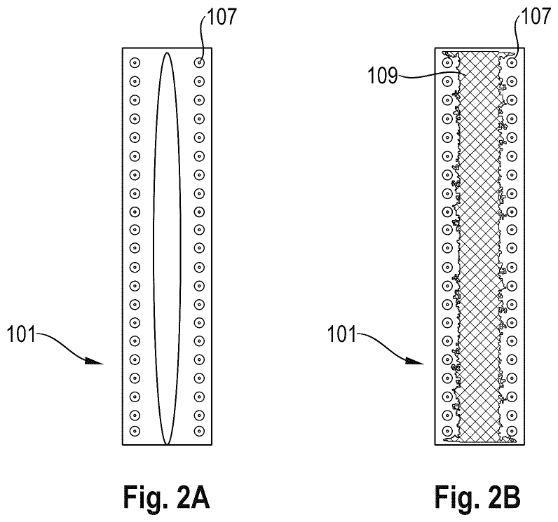

FIG. 2A shows a schematic external view of a nozzle plate 101 without deposits. The nozzle plate 101 comprises a plurality of nozzles 107 arranged in two parallel rows. A printing liquid is discharged from the nozzles 107.

FIG. 2B shows a nozzle plate 101 with deposits 109. The deposits 109 are formed during printing by dried printing liquid. For example, dried slurry residues form on the bottom side of the nozzle plate 101 around the nozzles 107. If these deposits 109 are not removed, the print quality decreases and clogging occurs at the nozzles 107.

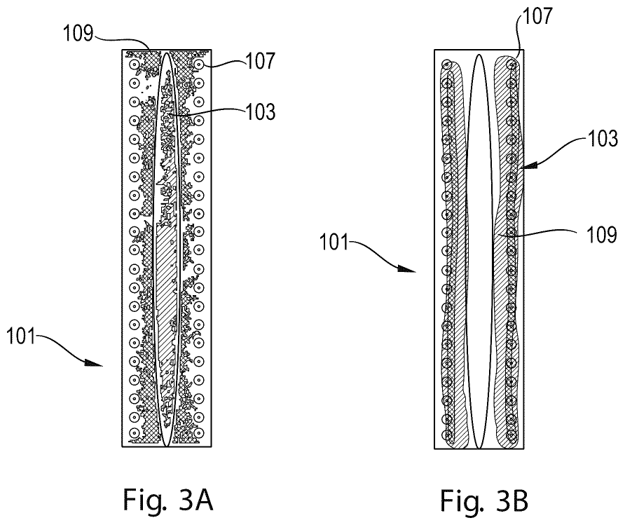

FIG. 3A shows a schematic view of the nozzle plate 101 with an applied film of water as carrier liquid 103. The carrier liquid can generally be any suitable solvent. The water 103 is applied to the center of the nozzle plate 101 and acts upon the deposits 109. The water 103 dissolves the dirt. During an operation of the 3D printer, water vapor is applied to the nozzle plate 101 or fine water droplets are sprayed onto the nozzle plate 101. As a result, the nozzle plate 101 is wetted. Instead of water, the carrier liquid of the respective printing liquid can also be used.

FIG. 3B shows a schematic view of the nozzle plate 101 with a dissolved deposit 109. The print head 105 is operated with a slight negative pressure during printing so that the printing liquid does not drop out. The negative pressure can be used to adjust whether a small amount of the water is sucked in or whether wetting is sufficient. The dissolved deposit 109 can be sucked in through the nozzles 107.

This ensures that all nozzles 107 of the nozzle plate 101 are always functional without having to move to a separate cleaning station. The latter saves costs, assembly space and increases the printing speed. In order to enhance the cleaning effect, the negative pressure can be temporarily increased. Since keeping the nozzles 107 open and cleaning the nozzle plate 101 takes place during a printing operation (on the fly), there is no interruption caused by moving to a separate cleaning station. In addition, it can be ensured that no print nozzle fails. The jetting process can be controlled so that there is no local drying of the slurry on the bottom side of the nozzle plate 101.

The solution absorbed during cleaning can then be collected in a tank and can be evaporated under vacuum so that it is removed again. As a result, the solids concentration does not change if a small amount of non-particle-containing liquid continuously enters the system.

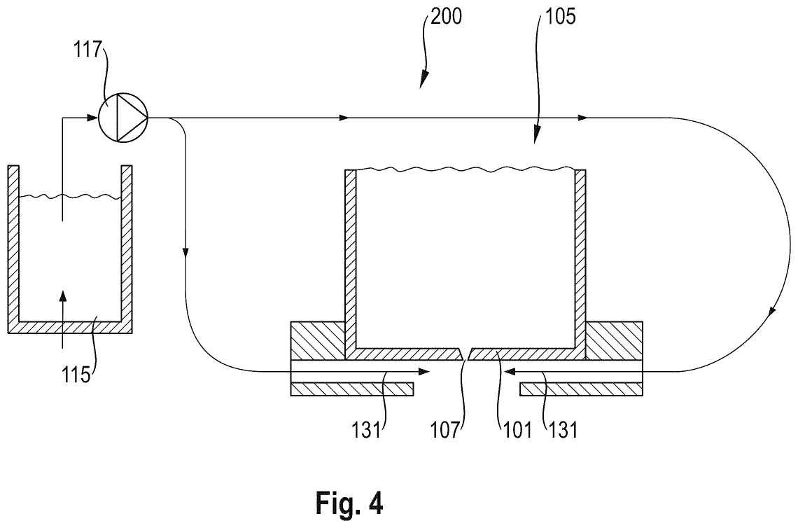

FIG. 4 shows a schematic view of a humidification system 200 for the print head 105. The humidification system 200 comprises a water tank 115 in which water 103 for humidifying the nozzle plate 101 is stored. The water 103 is delivered to the print head 101 via conduits through a pump 117.

An outlet nozzle 131 is located on each side of the nozzle plate 101. The outlet nozzles 131 discharge the water 103 from the water tank 115 onto the nozzle plate 101. This not only moistens the nozzle plate 101, but also increases the air humidity in the spatial area in front of the nozzle plate 101. The re-dissolved solid is thereby returned to the liquid system through the nozzles 107 by means of a negative pressure.

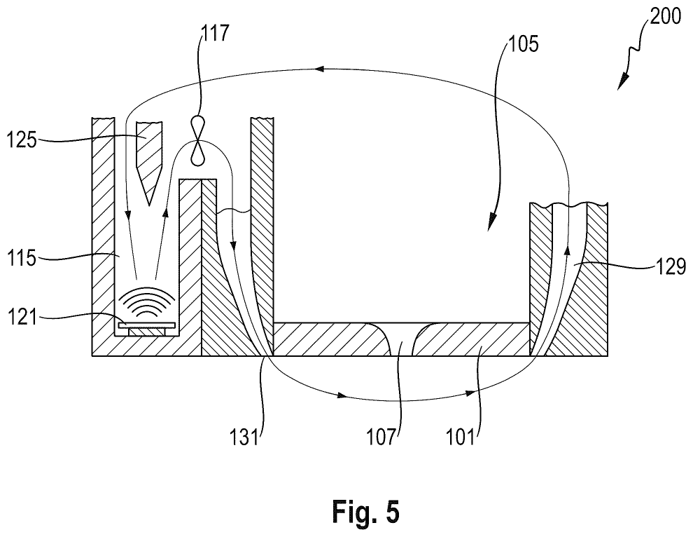

FIG. 5 shows a further schematic view of a device or system 200 for increasing a saturation level for the print head 105. The system 200 also includes a water tank 115 that stores water 103 for moistening the nozzle plate 101.

An ultrasonic piezo element 121 is arranged in the water tank 115 as an atomizer (vaporizer). The ultrasonic piezo element 121 generates ultrasonic vibrations within the water tank 115 near the water surface. The ultrasonic piezo element 121 converts electrical vibrations into mechanical vibrations. The mechanical vibrations result in the formation of capillary waves at the surface of the liquid film, which rise exponentially as the excitation frequency increases. When the excitation frequency reaches a certain value, droplets of a certain diameter are formed. The fog is generated by means of mechanical vibrations of up to 3 MHz, which are transferred to the liquid. The diameter of the droplets decreases with increasing excitation frequency or a higher density and lower surface tension of the respective liquid. By means of the ultrasonic piezo element 121, droplet sizes of 2 to 4 μm can be achieved. The ultrasonic piezo element 121 causes the water from the water tank 115 to be atomized or evaporated.

This forms a fog 125 of fine liquid droplets above the water surface. The fog 125 generated in this way is directed across the nozzle plate 101 by means of a recirculation system using a blower or pump 117 via an outlet nozzle (outlet) 131 and a suction nozzle (inlet) 129. After being sucked off by the suction nozzle 129, the fog 125 is returned to the water tank 115.

The outlet nozzle 131 and the suction nozzle 129 may be arranged in the same plane as the nozzles 107 or may be directly integrated into the nozzle plate 101. The outlet nozzle 131 and the suction nozzle 129 ensure that a laminar flow is generated below along the nozzle plate 101 from a fog 125 with a high degree of humidity. This prevents a moisture gradient from developing between the slurry and the atmosphere in the immediate vicinity of the nozzles 107.

The laminar flow below/along the nozzle plate 101 should have a flow velocity many times smaller than the exit velocity of the material droplet, so that the flying direction of the material droplet is not deflected too much. In addition, the laminar flow should be approximately orthogonal to the flying direction of the material droplet, ideally at right angles to the nozzles 107 arranged in series. The flow can be interrupted during the printing of individual material droplets so that this does not affect the printing result.

The laminar air flow with high humidity, which is applied to the bottom side of the nozzle plate 101, achieves that the water absorption by the ambient air at the nozzles 107 is prevented and thus the slurry does not dry out. This prevents deposits 109 at the nozzles 107 and at the nozzle plate 101.

The method reduces a technical effort and saves assembly space, since no separate cleaning station for the nozzle plate 101 is required. Since cleaning can be carried out during the printing operation, printing orders can be completed more quickly.

Alternatively, the atmosphere of the entire assembly space of the 3D printer may be kept moist such that the slurry at the bottom side of the nozzle plate 101 has no opportunity to release moisture into the environment and thus dry out.

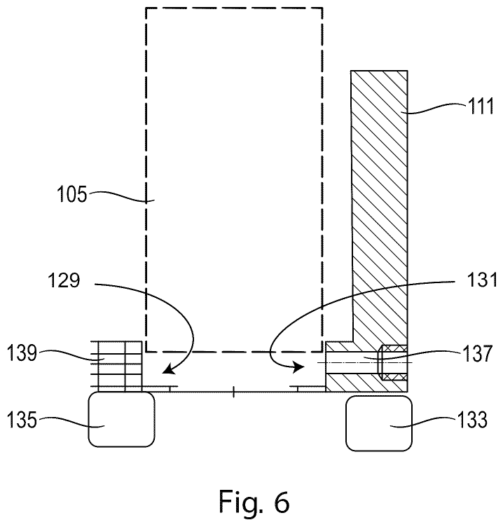

FIG. 6 shows a schematic view of a receptacle 111 for the print head 105. The receptacle 111 is formed by a molded part into which the print head 105 is inserted from above. The receptacle 111 may include a feed channel 137 and a discharge channel 139 that couple to the outlet nozzle 131 and the suction nozzle 129. The water vapor or water is fed or discharged via the feed channel 137 and the discharge channel 139.

Anything needed to ensure a reliable operation of the print head 105 can be integrated into the receptacle 111 of the print head 105. These components thereby travel with the print head 105, such as a vacuum port, a compressed air port, an ultrasonic generator, an evaporator, or an aerosol generator. No separate cleaning station needs to be approached or no separate cleaning station needs to be moved under the print head if it remains in place and the assembly platform moves.

Additionally, the receptacle 111 may comprise an evaporator or evaporation device 133 for generating water vapor in front of the nozzle plate 101. In the evaporation device 133, water 103 in the environment of the nozzle plate 101 is heated by means of a heating device in order to generate water vapor. The evaporated water 103 condenses at the nozzle plate 101. As a result, not only the air humidity in the environment of the nozzle plate 101 is increased, but also the nozzle plate 101 is wetted with a liquid film that prevents deposits 109.

The receptacle 111 may also comprise a sprayer or spraying device 135 for spraying water 103 onto the nozzle plate 101, for example by means of a nozzle. The nozzle plate 101 can also be wetted with water 103 by means of the spraying device 135, so that deposits 109 can be prevented by a liquid film.

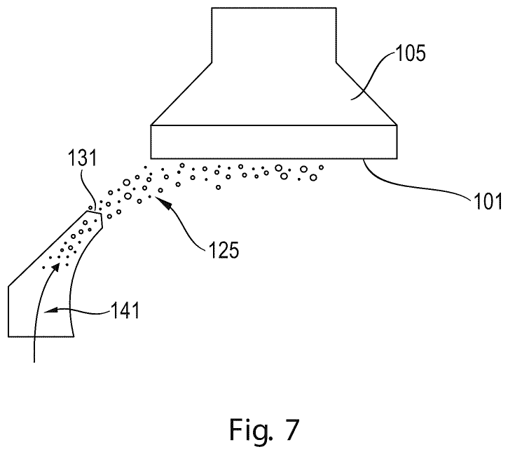

FIG. 7 shows a schematic view of a print head 105 and a water vapor generator 141. The water vapor generator 141 can for example be designed as an ultrasonic piezo element, which is arranged in a water tank. The 3D-printer can comprise a vapor generator, a heater or both as a system for increasing a saturation level of a carrier liquid of the printing liquid in the air in front of the nozzle plate.

The fog 125 generated is directed towards the nozzle plate 101 using a blower or pump 117 via an outlet nozzle (outlet) 131. The fog 125 can condensate at the nozzle plate 101 and from there drop down as water droplets. In a non-horizontal assembly platform these water droplets can be collected in a collection tray, which can again feed the water tank so that a re-absorption or re-suction of the carrier liquid into the nozzles is prevented.

The fog 125 for increasing the saturation level can have a temperature of 50° C. or above. Fog 125 with a temperature of at least 50° C. can effectively soften dried or deposited printing liquid on the nozzle plate 101. This has the technical advantage, for example, that deposits on the nozzle plate 101 can be removed efficiently, easily and fast. The use of water-fog 125 with a temperature of at least 50° C. to 60° C. makes the use of aggressive chemicals unnecessary. This has the further technical advantage, that the nozzle plate 101 can be cleaned effectively without the need for harsh chemicals that could lead to corrosion.

In this case condensed carrier liquid is formed on the surface of the nozzle plate 101. If the nozzle plate 101 has a temperature between 20° C. to 25° C. and the vapor of the carrier liquid for increasing saturation is between 50° C. to 60° C., a cleaning of the nozzle plate 101 is highly effective. The atmospheric pressure can be 1.013 hPa. A possible maximum saturation level of the carrier liquid can be found in a Mollier-diagram which is a graphic representation of the relationship between air temperature, moisture content and enthalpy of air at a predefined pressure.

All of the features explained and shown in connection with individual embodiments of the invention may be provided in different combinations in the subject matter of the invention to simultaneously realize their beneficial effects.

All method steps can be implemented by devices which are suitable for executing the respective method step. All functions that are executed by the features in question can be a method step of a method.

The scope of protection of the present invention is given by the claims and is not limited by the features explained in the description or shown in the figures.

### REFERENCE LIST

100 3D printer
101 nozzle plate
103 carrier liquid/water
105 print head
107 nozzle
109 deposits
111 receptacle
113 feeding device
115 water tank
117 pump
119 assembly platform
121 ultrasonic piezo element
123 print jet
125 fog
127 dental restoration
129 suction nozzle
131 outlet nozzle
133 evaporation device
135 spraying device
137 feed channel
139 discharge channel
141 water vapor generator
200 system

1. A method for preventing deposits of a printing liquid at a nozzle plate of a print head within a 3D printer, comprising
increasing a saturation level of a carrier liquid of the printing liquid in air in front of the nozzle plate.

2. The method according to claim 1,
wherein the nozzle plate is wetted with the carrier liquid.

3. The method according to claim 1,
wherein the carrier liquid is vapor deposited onto the nozzle plate.

4. The method according to claim 1,
wherein the carrier liquid is sprayed onto the nozzle plate.

5. The method according to claim 1,
wherein the carrier liquid is nebulized in front of the nozzle plate.

6. The method according to claim 5,
wherein the carrier liquid is atomized by ultrasound.

7. The method according to claim 1,
wherein the carrier liquid on the nozzle plate is sucked in through the nozzles.

8. The method according to claim 1,
wherein the carrier liquid is applied to the nozzle plate before, during or after a printing operation.

9. The method according to claim 1,
wherein the carrier liquid or air enriched with carrier liquid is discharged via an outlet nozzle or the carrier liquid is applied to the printing plate by a cloth or sponge.

10. The method according to claim 1,
wherein the carrier liquid or air enriched with carrier liquid is sucked off via a suction nozzle at the nozzle plate.

11. The method according to claim 1,
wherein the carrier liquid for increasing the saturation level has a temperature above 50° C.

12. A 3D printer with a nozzle plate, comprising:
a system for increasing a saturation level of a carrier liquid of a printing liquid in air in front of the nozzle plate.

13. The 3D printer according to claim 12, comprising
an evaporator for generating vapor of the carrier liquid in front of the nozzle plate,
an ultrasonic nebulizer for generating nebulized carrier liquid in front of the nozzle plate, and/or
a sprayer for spraying the carrier liquid onto the nozzle plate.

14. The 3D printer according to claim 12,
wherein an outlet nozzle for increasing the saturation level is arranged at the nozzle plate.

15. The 3D printer according to claim 12,
wherein a suction nozzle is arranged at the nozzle plate for sucking off carrier liquid or air enriched with carrier liquid.

16. The 3D printer according to claim 15,
wherein the outlet nozzle is arranged on one side of the nozzle plate and the suction nozzle is arranged on the other side of the nozzle plate.

17. The 3D printer according to claim 12, comprising
a heater for heating the carrier liquid, increasing the saturation level.
